(19) United States
(12) Patent Application Publication
(10) Pub. No.: US 2012/0059346 A1
(43) Pub. Date: Mar. 8, 2012

(54) VIAL HANDLING AND INJECTION SAFETY SYSTEMS AND CONNECTORS

(75) Inventors: Ian Graham Sheppard, Burnaby (CA); Jeffrey Howard Davis, Richmond (CA); Derek Blackstock, Richmond (CA); Christopher Grant Denny, Victoria (CA); Gregory Vincent Browne, Victoria (CA); Martin John Forbes, Richmond (CA)

(73) Assignee: BRITISH COLUMBIA CANCER AGENCY BRANCH, Vancouver, BC (CA)

(21) Appl. No.: 13/128,795

(22) PCT Filed: Nov. 12, 2008
(86) PCT No.: PCT/CA2008/001999

§ 371 Date: Nov. 9, 2011

(51) Int. Cl. A61J 1/20; A61J 1/14

(52) U.S. Cl. 604/414; 604/403

(57) ABSTRACT

Systems and devices are provided to facilitate safe handling and injection of medicaments contained in vials. A vial handling system has at least one vial gripping member to hold a vial, and a filler pin movable relative to the vial gripping member for piercing a membrane seal on the vial. At least one window is provided in the vial handling system to permit access to remove a cap on the vial, while preventing needle access to the membrane seal through the window. In some embodiments, the vial contents are removed through a male end connector portion of a unique connector pair. A female end connector portion has a female socket with an inner fluid tube in fluid communication with a body of a syringe, while the male end connector portion has an engaging end dimensioned to fit within the female socket and securely overlap the inner fluid tube.

### TECHNICAL FIELD

The invention relates to vial handling and injection safety systems for administering pharmaceutical agents, and in particular to vial handling and injection safety systems and connectors designed to avoid accidental administration of an incorrect pharmaceutical agent to a patient.

### BACKGROUND

Some medications are administered intravenously or intramuscularly whereas others may be administered into the various spinal spaces (i.e., into the intrathecal or epidural spaces surrounding the spinal cord), among other methods. Medications suited for one route of administration may be very toxic in another route of administration (for example, inadvertent vinca alkaloid administration intrathecally, or unintended bupivacaine administration intravenously). The syringes used for each of the different procedures may be very similar or identical, and an interchange of medications, or an error in the route of dose administration resulting from a variety of human error factors may be very serious and has been shown to be fatal in many cases.

Further, some medications used in the spinal route are themselves very dangerous to medical personnel, and accidental exposure of personnel to such medications must also be prevented.

Further, integrity of the medication must be preserved over the whole period from the time of receipt at the health facility, through the various handling processes including storage, dose preparation and assembly into the syringe, dose transportation, and finally, administration of the injection. Errors can occur at any stage in the process and it may not be possible to identify those errors at a later stage. A system designed to reduce the opportunity for such errors should address all of the stages in the use of the medication, and decrease reliance on sustained human attentiveness as the sole defense against serious errors.

While written procedures are an important part of these processes, they primarily attempt to control human functions, which functions have been shown to be susceptible to various quality defects. It is therefore desirable to have a set of devices and methods that reduce the chance for error by incorporating physical components that are not only recognizably distinct and incompatible with other systems, but are also resistant to deliberate improvisation. It is desirable that such components by their very design and characteristics lead naturally to simple and error free use.

### DESCRIPTION OF CONVENTIONAL SYRINGE HANDLING PROCEDURES

Medication or pharmaceutical agents are commonly delivered to a medical facility in sealed vials 3 (FIG. 1). These vials are supplied in various sizes, but in general have a configuration including a removable protective cap 1 which protects the inner seal, typically vial membrane 2, which is, in turn, intended to retain the purity of the contents 4 (FIG. 5). A protective foil (not shown in FIG. 1) may also overlie the membrane, between the membrane 2 and the protective cap 1.

In the prior art, the conventional procedure to transfer the contents 4 (or a portion of the contents) of the vial 3 to a syringe firstly consists of cleaning the membrane surface of the inner seal and then perforating this seal by a piercing device (FIG. 2), commonly known as a “filler pin” (shown as 14). This piercing device typically consists of a sharp hollow stem 11 mounted to a cavity containing a filter membrane 12. The point of the stem 11 is pressed through the vial membrane 2, which then seals around the shaft of stem 11. A lumen 15 within this stem connects the contents of the vial to the filter membrane cavity. Most filter membrane cavities allow air exchange through a venting mechanism to equalize pressure within the vial when the seal is pierced and the contents removed, while yet preventing external contamination from entering the vial, or preventing any aerosol of the vial contents being released outside the filter cavity. The administering syringe is then filled by removing the filler pin sealing cap 13, securely attaching the syringe to the exposed connector and withdrawing the contents through the filler pin lumen 15.

It is known that, as a shortcut, and further because the filler pin 14 is often difficult to push through the vial membrane 2, assembly personnel may simply use a needle on the syringe itself to directly perforate the vial membrane 2 to fill the syringe. A second needle might be used to provide a path for air pressure equalization. This inappropriate series of actions exposes the remaining vial contents to contamination, and potentially exposes the personnel to vial contents which may leak (possibly in aerosol form) from the needle perforation. There is a need for systems, devices and connectors that provide safeguards to prevent such shortcuts and inappropriate actions.

Further, it is known that the prior art filler pin design 14 is such that the last portion of the contents may not be readily accessed by the needle tip, leading to a waste of medication.

Further, the filler pin 14 may easily be removed from the vial 3, either accidentally or intentionally. Either action may result in undesirable contamination of the contents or exposure of personnel to vial contents 4.

Further, it is possible to reuse a previously used filler pin on another (or the same) vial, leading to the distinct probability of error, contamination, cross contamination, and/or exposure.

The needle portion of prior art systems that are conventionally used for the injection of spinal medication are of two separable parts: an outer sharpened metal tube with its lumen containing an inner metal filler rod known as a stylette. The two are mated together and the mated pair ground to a sharp bevel point in manufacture to better penetrate the tissue of the patient. The stylette tip is thus also ground to the same bevel, flush with the bevel of the needle tip. This configuration is intended to cause the stylette to fill the hollow tip of the needle and prevent the sharpened bevel surface of the lumen from cutting a core from the tissue as the needle is inserted.

In the spinal injection process the needle is inserted into the patient to the estimated location required and the stylette is withdrawn. If the needle has been properly positioned, it is normal to observe (and possibly collect) the spinal fluid that drips from the open end of the needle. If it is found that the needle has not been properly positioned in the patient, the stylette must be re-inserted fully into the needle lumen, with its bevel correctly oriented, before the needle is repositioned in the patient, so as to once again prevent the cutting of a core of tissue.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In one embodiment, a vial adapter for managing the removal of vial contents has at least one gripping member adapted to permanently receive the vial, at least one window dimensioned to permit access to remove a cap on the vial, and a filler pin movable relative to the vial gripping member to pierce a membrane on the vial. An angle defined between a surface on a membrane of the vial and an upper portion of the window is less than 80 degrees, and may be less than 55 degrees.

In some embodiments, the vial gripping member may have a plurality of vial gripping arms. The vial adapter may have a male end connector portion of a unique connector pair through which the vial contents may be removed, the male end connector portion having an engaging end dimensioned to fit within a female socket on a female end connector portion of the unique connector pair, and dimensioned to securely overlap an inner fluid tube on the female end connector portion. The filler pin may be a piercing stem having first and second lumens extending through a tip of the piercing stem, and the first lumen may be in fluid communication with the male end connector portion.

In some embodiments, a reversed connector pair for use with pharmaceutical agents has a female end connector portion with a female socket with an inner fluid tube in fluid communication with a body of a syringe, and a male end connector portion having an engaging end dimensioned to fit within the female socket and securely overlap the inner fluid tube. The male end may have at least one blocking member disposed to accommodate the female socket, and the male end may have at least one projection on a tip of the engaging end. The blocking member may be a pair of opposed blocking arms. The female socket may have a helical slot, and an inner surface of the blocking arms may be dimensioned to engage with the helical slot. The inner fluid tube may be made of transparent or semi-transparent material.

In some embodiments, a drug safety system for injecting a drug from a vial may have a vial adapter for managing the removal of vial contents. The vial adapter has at least one vial gripping member adapted to receive the vial, a filler pin movable relative to the vial gripping member to pierce a membrane on the vial, and a male portion of a unique connector pair in fluid communication with the filler pin, the male portion having an engaging end. A safety syringe for removing the vial contents from the vial adapter has a female portion of the unique connector pair at an end of the safety syringe. The female portion has a female socket with an inner fluid tube in fluid communication with a body of the safety syringe. The engaging end of the male portion is dimensioned to fit within the female socket and securely overlap the inner fluid tube. The male end may have at least one blocking member disposed to accommodate the female socket, and may further have at least one projection on a tip of the engaging end.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 shows a typical commercial medication vial.

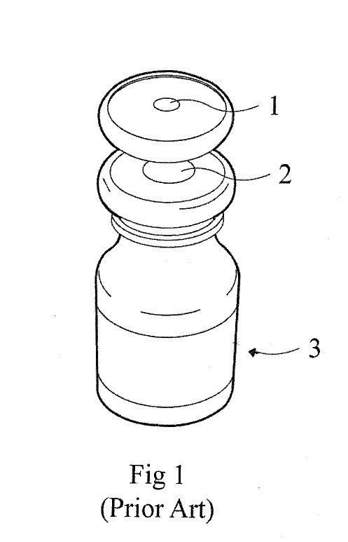

FIG. 2 shows an example of the prior art filler pin (i.e. a septum piercing and filtering device).

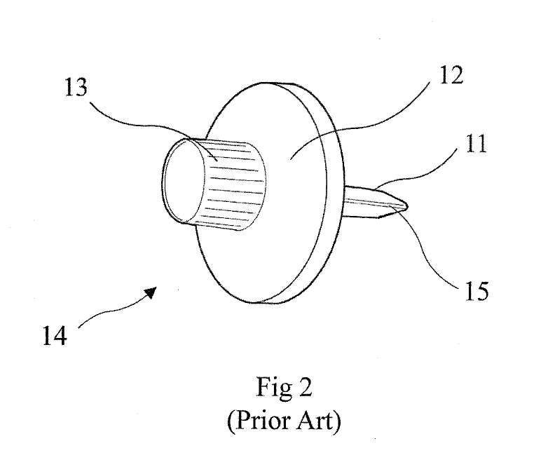

FIG. 3 shows an embodiment of a vial handling system.

FIG. 4 shows the embodiment of the vial handling system shown in FIG. 3, as used in an initial step of operation.

FIG. 5 shows a cross-sectional view of the FIG. 4 embodiment.

FIG. 6 shows the embodiment of the vial handling system shown in FIG. 3, as used in a further step in the operation just before compression of the upper and lower chambers.

FIG. 7 shows the embodiment of the vial handling system shown in FIG. 3 with a vial housing connector exposed.

FIG. 8 shows the embodiment of the vial handling system shown in FIG. 3 with the syringe connected.

FIG. 9 shows an embodiment of a safety syringe.

FIG. 10 shows an embodiment of a mating syringe cap.

FIG. 11 shows an embodiment of a safety needle.

FIG. 12 shows details of a male portion of a unique mating end of an embodiment of a unique connector pair.

FIG. 13 shows details of a female portion of a unique mating end of an embodiment of a unique connector pair.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

One embodiment of a safety syringe system according to the invention provides a set of syringe and vial handling components that, by their design, lead to a methodology of medication preparation and administration conducive to reducing the opportunity for human error. For obtaining maximum benefit from the safety syringe system, all three components (a vial handling system with a unique connector, a safety syringe with its corresponding unique connector and other features, and a safety needle) should be used together. However, portions of the system also have application to improve other systems.

Embodiments of the safety devices and connectors described below have application, for example, in the areas of spinal injections from syringes or other spinal insertion apparatus, including, for example, an in-dwelling spinal soft catheter such as that used in patients requiring epidural anaesthesia or pain control. Spinal injections using the safety devices and connectors described below may be used, for example, for injection into the epidural, intrathecal or intravascular spaces within the spine.

### Vial Handling System

One embodiment of a vial handling system contains a number of features which, by their design, help to define the steps of the operation of the system, add convenience, cleanliness and security measures, while yet maintaining conventional required functions.

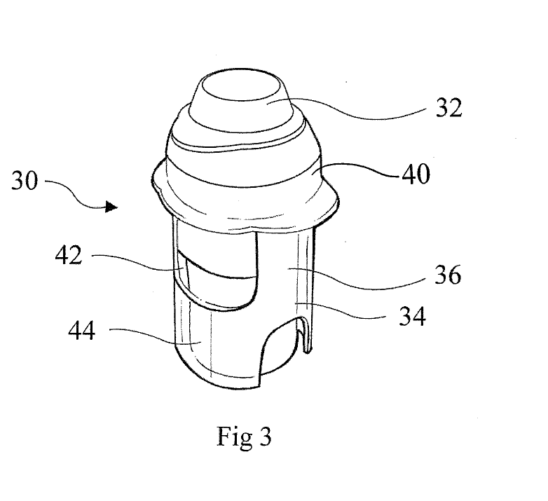

An embodiment of a vial handling system 30 (i.e. a vial adapter) illustrated in FIG. 3 to FIG. 8 includes a body 36 having a cylindrical housing 34 and a chamber 42 within the housing 34 which receives the vial of medication 3.

Lower portion 44 of housing 34 may be made transparent to allow the original vial packaging labeling to be fully visible to allow verification of its contents, while still retaining and protecting vial 3. Very small vials 3 may be fitted up inside housing 34, which then serves as a stand to allow them both to stay upright. The vial 3, contained within a vial handling system 30, may then be safely stored in this state with protective cap 1 still in place, secure from contamination, tampering, or misuse. Vial contents 4 may have a short shelf life after protective cap 1 has been removed.

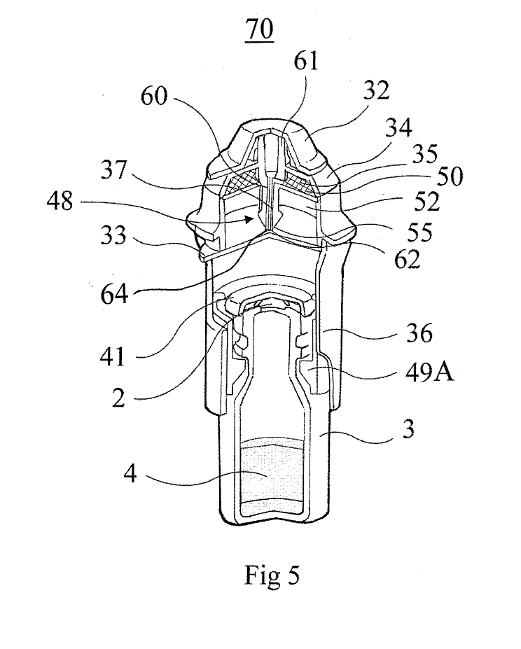

An upper portion 40 of body 36 includes a filler pin assembly 48 (FIG. 5). With reference to FIG. 5, the piercing stem (filler pin) 37 is located within a sterile sealed cavity 52 whose limits are defined by the housing 34, a removable seal membrane 33, and a removable protective sealing cap 32. Sealed cavity 52 also contains a fine pore membrane filter 35. Sealed cavity 52 is intended to retain its sterility after vial handling system 30 is removed from its packaging, and after vial 3 has been inserted into vial handling system 30.

A full safety syringe system process initially begins when vial 3 is received at the medical facility. Vial handling system 30 has previously been sterilized, and stored in conventional medical product packaging (not shown). Vial handling system 30 is fitted over the vial 3 and snapped on, and vial 3 is securely retained by a gripping member.

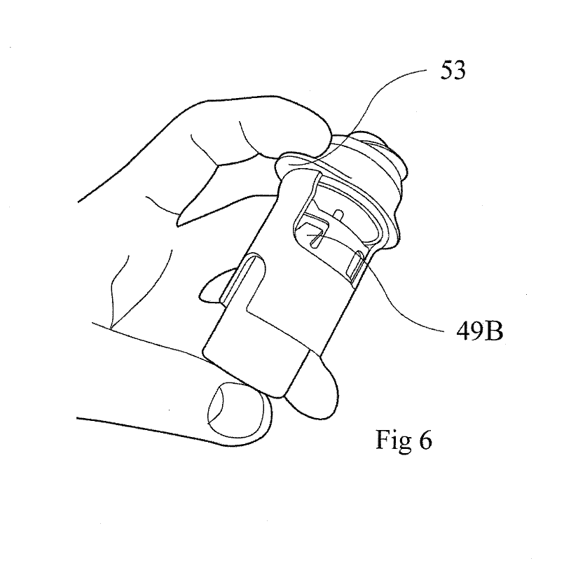

Alternate embodiments of gripping arms 49A and 49B, which act as the gripping member in the illustrated embodiments, are shown in FIG. 5 and FIG. 6, respectively. Gripping arms 49A and 49B have an inwardly tapered lower surface, such that vial 3 may be inserted past gripping arms 49A and 49B. Gripping arms 49A or 49B thus deflect outwardly on insertion of vial 3. However, the upper surface of gripping arms 49A and 49B is shaped to securely and permanently retain vial 3 once vial 3 has been snapped into vial handling system 30. For example, the upper surface of gripping arms 49A and 49B may be generally flat to securely retain vial 3, as shown in FIG. 5 and FIG. 6. In the illustrated embodiments, vial 3 cannot be removed from vial handling system 30 without causing physical damage to gripping arms 49A and 49B (e.g. by snapping at least one gripping arm), and accordingly vial 3 is securely and permanently retained within vial handling system 30. Many other designs are possible to provide this secure retention function. For example, a collar could be molded into the vial, an adhesive could be used to bond a collar onto a vial, a pin or a strap could be used to provide locking between body 36 of vial handling system 30 and vial 3, or a threaded connection or bayonet mount could be used to connect a collar to a vial.

Vials 3 are supplied in various sizes from different manufacturers and have different sized necks, so adapters (not shown) may be made available to allow vial handling system 30 to fit a range of available vial neck sizes.

Once securely inserted into the gripping member, vial 3 may not be subsequently removed from vial handling system 30 without damage or visible evidence. Further, there is no direct needle access path to the vial contents 4, as discussed below, so that the contents may not be improperly accessed in that fashion.

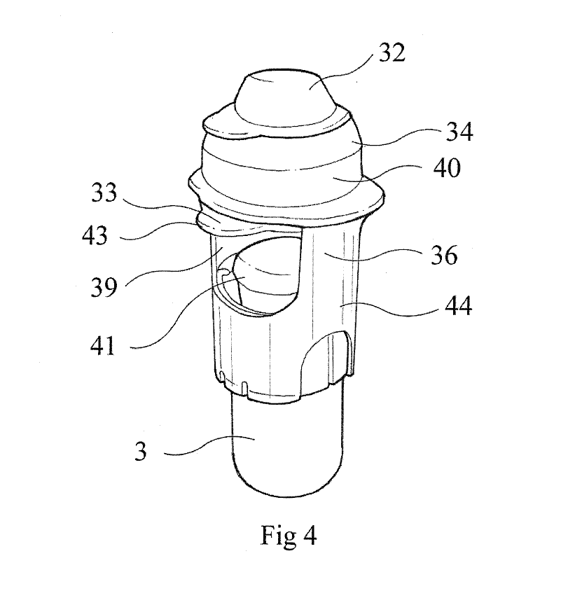

When the contents 4 are to be transferred to a syringe 71, the upper portion 40 of the assembly is withdrawn a short distance from the lower portion 44 (FIG. 4), exposing in a window 39 the manufacturer's original vial cap 41 and the piercing cavity lower seal 33.

The exposed vial cap 41 is manually removed by lifting it off (through the window 39) in the conventional manner. The exposed vial membrane 2 may be disinfected by swabbing in the conventional manner. It is important to note that, as a security measure, the window 39 presented, while large enough to allow cleaning and tab removal, is not made large enough, or in an appropriate position, to allow a syringe needle to access (even at an angle) and perforate the vial membrane seal 2. Such an access would allow improper withdrawal of the vial contents 4 by insertion of a conventional needle through window 39.

Access to vial contents 4 is prevented by window 39 because commonly available vials are arranged so a needle must be close to perpendicular to the vial membrane 2 in order to penetrate it and reach the contents 4. In one embodiment window 39 is arranged to prevent a needle from approaching vial membrane 2 at an angle of greater than 80 degrees from the septum surface, because an angle defined between an upper portion of window 39 and a plane defined by the surface of vial membrane 2 is less than 80 degrees. In another embodiment angles of 55 degrees and higher are prevented, because an angle defined between an upper portion of window 39 and a plane defined by the surface of vial membrane 2 is less than 55 degrees. This arrangement of window 39 protects vial membrane 2 from being penetrated by inappropriate syringe access through window 39.

Next, the sterile piercing cavity lower seal 33 is removed by pulling on its tab 43.

To continue the filling process, the membrane seal 2 on the vial 3 is then perforated by pressing down with the palm of the hand on the upper portion 40 of the housing, compressing it such that filler pin assembly 48 extends into the lower portion 44, and into vial 3. Alternatively the assembly may be compressed between the thumb and fingers (FIG. 6) using the flanges 53 provided on upper portion 40. Piercing stem 37 is movably mounted on vial handling system 30 relative to gripping arms 49A or 49B to allow piercing stem 37 to be inserted into vial 3 in this manner.

Top cap 32 is preferably not removed until a syringe is to be connected, to maintain the sterility of chamber 50.

The characteristics of the internal portions of the vial handling system 30 will now be discussed. The filler pin assembly 48 contains two lumens 60, 62. One of the lumens 60 passes through the piercing stem 37 from a filler port 64 near the shaft tip 55 to a vial housing connector 61 at the top end of the filler pin assembly 48 (under top cap 32). Vial housing connector 61 is intended to allow removal of the vial contents 4, and is in fluid communication with the outside atmosphere 70 when top cap 32 is removed.

The other lumen 62 passes through the piercing shaft 37 from near the shaft tip 55 to cavity 50 under top cap 32 that is in turn in fluid communication with the outside atmosphere 70 via a fine pore membrane filter 35. This path is intended to allow filtered air exchange between cavity 50 and vial 3. It allows air to escape if the vial 3 is at higher than ambient pressure when membrane seal 2 is perforated, and yet the fine pore filter 35 will not allow any of the contents 4 to be released, even as an aerosol. As the syringe 71 is filled and the liquid vial contents 4 are withdrawn, replacement air may enter via the filter membrane 35 and the second lumen 62 to replace the volume previously occupied by the contents 4 that have been removed. The membrane 35 will filter potentially harmful material from the replacement air so as to not contaminate the remaining vial contents 4.

The tip 55 of the piercing shaft 37 preferably forms a barbed end to prevent it from being subsequently fully withdrawn from the membrane seal 2, further reducing the opportunity for misuse or contamination. The barb feature on the piercing shaft tip 55 additionally allows the filler port 64 on the end of the shaft 37 to be safely positioned near to the seal membrane 2 without fear of full withdrawal, allowing a greater majority of the vial contents 4 to be accessible through the filler lumen 60 (when the vial is inverted) thus reducing waste of the contents 4.

In some embodiments, the design of the two lumens 60, 62 is such that there is no direct needle path into the vial 3 through the lumens 60, 62 of the piercing stem 37, because lumens 60 and 62 form a twisted path. This feature is intended to prevent the contents 4 from being improperly accessed by a conventional syringe needle. In some embodiments, the vial housing connector 61 is a male portion of a unique connector pair, and is not compatible with any known conventional syringe, so the contents 4 may only be accessed by connecting a corresponding compatible female portion of the unique connector pair, normally on a compatible safety syringe 71.

Although a particular fluid path within vial handling system 30 has been illustrated and described, other fluid paths may be utilized. For example, vial handling system 30 may be modified with fluid path alterations as required to meet evolving standards to provide for a reduced potential for sterile fluid contamination (e.g. by providing a closed system that does not permit the vial contents 4 to be open to the air via a lumen), or for increased personnel safety (e.g. by reducing the potential for aerosolized or surface contamination when handling vials with biohazardous agents).

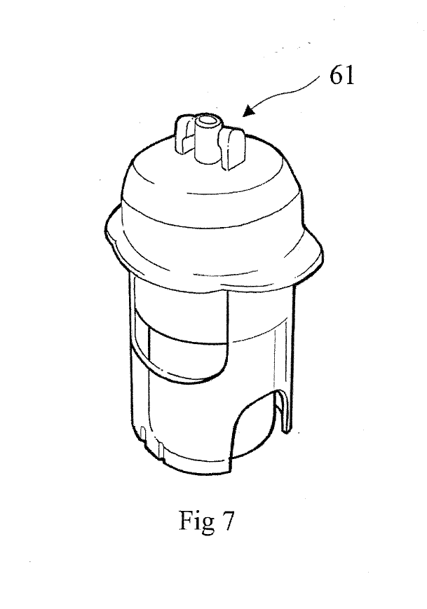

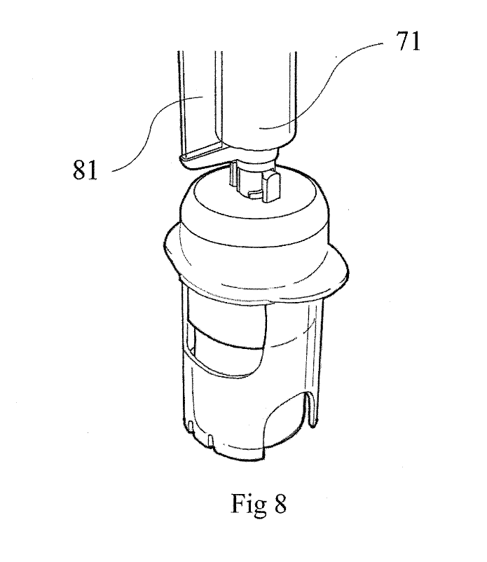

The vial handling system 30 is now ready for the transfer of the vial contents 4 to the syringe 71. The top cap 32 of the assembly is removed to expose the vial housing connector 61 (FIG. 7). This connector is specifically designed to be unique, i.e. mechanically incompatible with any push-on (slip tip) or twist-lock syringe fitting known as of the filing of this specification. The unique connector design has special mechanical features that prevent a secure fit between the unique connector and any known push-on or twist-lock syringe fitting, thereby precluding the transfer of the vial contents 4 to any such known device. In some embodiments, vial housing connector 61 is a male connector portion of a unique connector pair, as described in greater detail below. Vial housing connector 61 may have a diameter that is different than any connectors known at the time of filing this specification, and is specifically designed to not allow a temporary flush mating surface connection. Further, horns 111 and projections 114, discussed below, preclude a flush mating with tubing or engagement with conventional syringes. The vial contents 4 may thus only be accessed by mating a compatible female portion of the unique pair on syringe 71, which can be mated fully with a locking twist action connection, as shown in FIG. 8.

### Safety Syringe

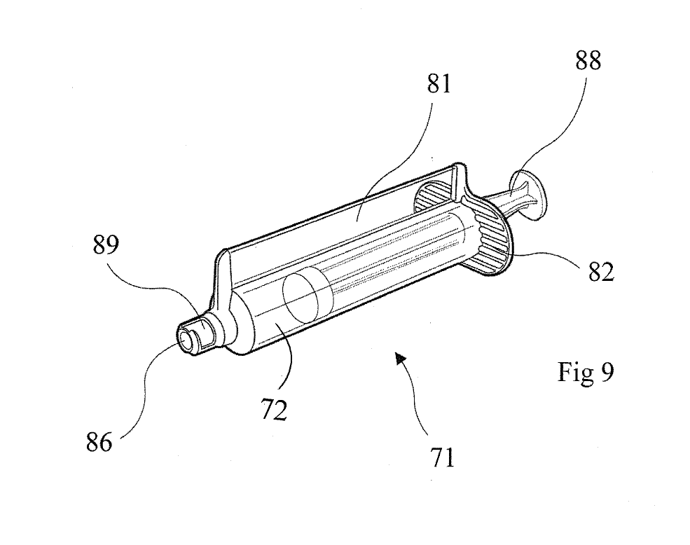

A safety syringe 71 (FIGS. 8 and 9) according to one embodiment of the invention contains a number of features which are intended to ease procedures and further reduce the opportunity for error. Safety syringe 71 includes a female connector portion of the unique connector pair in fluid communication with a body 72 of safety syringe 71 as a syringe connector 89. All or part of the female connector portion of syringe connector 89 may be made from transparent or semi-transparent material, to allow the fluid meniscus in the syringe to be easily observed. Safety syringe 71 thus has a “reversed male/female connector” (i.e. “reversed connector”) design, as conventional LUER-LOK™ syringes have a male mating end on the syringe.

A large side panel 81 on the syringe body provides an unobstructed flat area to attach additional instructional, warning or tracking labeling where it is clearly visible and easily affixed without interfering with the normal operation of the syringe 71. The presence of this side panel 81 is additionally, in itself, a visual distinction of safety syringe 71.

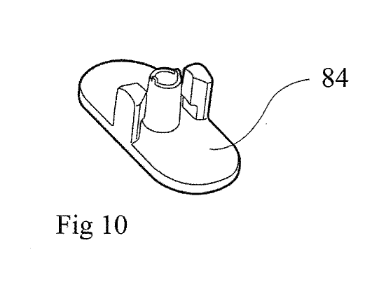

Those surfaces 82 of the syringe that are normally handled during use preferably have distinctive ridged features to provide tactile feedback as a reminder of the specific safety syringe type. After the syringe 71 is filled with vial contents 4, a mating syringe cap 84 (FIG. 10) is placed on the syringe end 86, again with a secure twist-lock fitting through a male connector portion of the unique connector pair, to safely secure the contents 4 until the connector is again exposed to attach a corresponding unique mating portion of a safety needle 90 at the time of use. A plunger 88 is sealingly inserted within body 72 of safety syringe 71, and is slideable longitudinally within the hollow body. Syringe 71 may be safely transported and stored for short periods in this capped state.

### Safety Needle

An embodiment of a safety needle 90 contains a number of features which are intended to further reduce the opportunity for administration error.

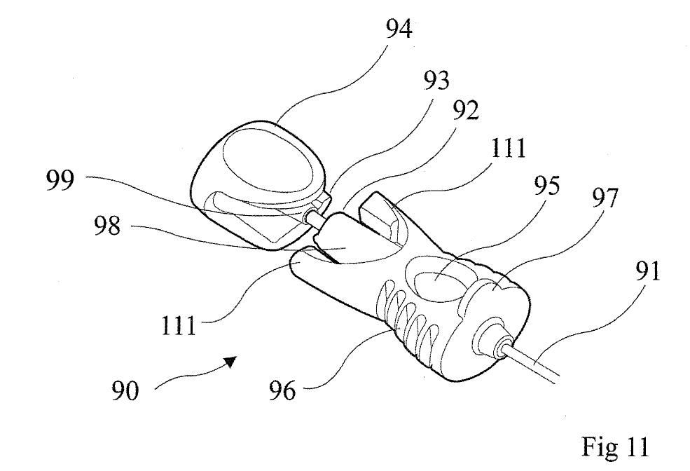

As shown in FIG. 11, the actual metal needle portion 91 of safety needle 90 may take the form of any of a number of conventional needle designs. The syringe end 98 of the metal needle 91 (also called the needle hub) is provided with a unique needle connector 92 which will only mate with the compatible unique syringe connector 89 of syringe 71 of this system. The stylette 93 is fitted with a compatible unique mating handling feature 94 that allows the stylette 93 to be withdrawn and correctly re-oriented for reinsertion, and subsequently retained within the needle portion 91. This handling feature on the stylette 93, when the stylette 93 is in place, also protects the needle connector 92 during insertion (or other needle handling procedures) when the syringe 71 is not installed.

At this point in the drug administration process the clinician normally attempts to remove all air from the contents of the syringe 71. This is conventionally performed by holding the syringe 71 in a generally vertical position until the air rises to the top and depressing the plunger 88 to eject the air from the open tip. It is common to press the plunger 88 far enough that the contents form a meniscus at the tip of the syringe, ensuring all the air is removed.

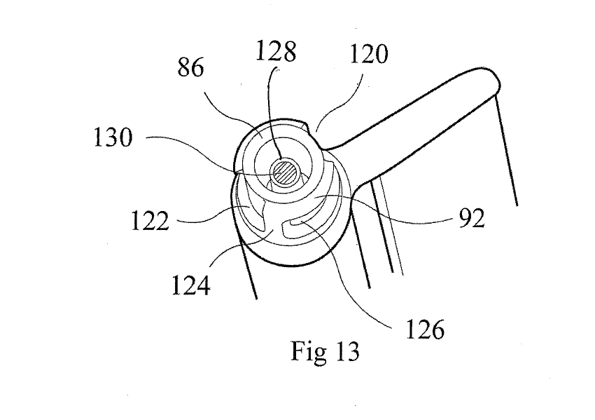

In the case of previous syringes of the “reversed male/female connector” type, this action leaves a pool of the medication in the female receptacle of the syringe tip that will be displaced and expelled when the needle is connected, producing a risk of exposure to the person administering the drug. In embodiments of a syringe according to the present invention, the syringe end 86 of the connector is of a form that does not leave such a pool of fluid that may be displaced. Specifically, a syringe fluid tube 128 (FIG. 13) is provided at the syringe end 86 which allows the meniscus 130 of the fluid to be easily seen, and is of narrower diameter than the full size of female part 120. The mating surface of the female part 120 is on the outside surface of the syringe fluid tube 128, so that fluid is not displaced during mating. Thus, the fluid meniscus 130 may be positioned without leaving a pool of fluid at the syringe end 86, and male part 110 may be mated to female part 120 without displacing fluid from female part 120, as would normally be the case with a reversed-mating connector engagement. Syringe fluid connector 92 thus fits cleanly to the end of the syringe connector 89 without displacing any fluid present at the tip of syringe 71, thereby protecting personnel from exposure to potentially dangerous compounds. Additionally, syringe fluid tube 128 may be made from transparent or semi-transparent material, to allow fluid meniscus 130 to be easily observed.

Particularly interesting features of the safety needle 90 include the ergonometric shaped handling portion 96 of the needle 90. This handling aspect of safety needle 90 allows for observed varied physician needle handling and insertion techniques. Safety needle 90 contains a male portion of the unique connector pair, needle connector 92, which is compatible with the female portion of the unique connector pair on syringe connector 89 of safety syringe 71, and deliberately incompatible with any other connector known as of the filing of this specification. It also contains features that are intended to prevent improvisation to allow the attachment of other known syringe systems.

To aid handling and ease of use the handling portion 96 is flattened, not circular, to make the needle bevel orientation (not shown) obvious. Handling portion 96 further has a projection 97, which provides a further indicator of the orientation of the needle bevel. Handling portion 96 is additionally distinctively ribbed for ease of use by a gloved hand.

Needle connector 92 may be made transparent or partially transparent, and may include a special “high visibility” area 95, so that the meniscus of the approaching spinal fluid is visible before it exits the needle connector 92. Stylette mating tip 99 is a unique mating connection portion compatible with needle connector 92, and mechanically seats into the needle connector 92 to provide a positive indication of full mating of stylette 93 with the safety needle 90. It is also shaped to enclose and protect syringe fluid connector 92 of safety needle 90 from contamination or damage.

Designs in accordance with that described above for safety needle 90 also have application in the construction of other spinal insertion apparatus besides needles. For example, aspects of the design of safety needle 90, including the stylette and the ergonometric shaped handling portion, may be used in other spinal insertion apparatus such as, for example, in-dwelling spinal soft catheter insertion applications, such as that utilized in patients requiring epidural anaesthesia or pain control.

### Safety Connector

The particulars of the unique connector pair 110, 120, which are not engageable with any conventional syringe/needle systems known at the date of filing this specification, will now be described. In the illustrated embodiment, the needle connector 92 and the vial housing connector 61 form the unique male part 110 of the compatible connector pair, which fits inside the unique mating female part 120 which forms syringe connector 89 located on the syringe 71. As explained above, connector pair 110, 120 is thus a “reversed male/female connector” type, as a conventional LUER-LOK™ fitting would provide a male end at a tip of the syringe, to be coupled with an engageable female end on a conventional needle. This reversed connector pair may be used to administer medication or pharmaceutical agents.

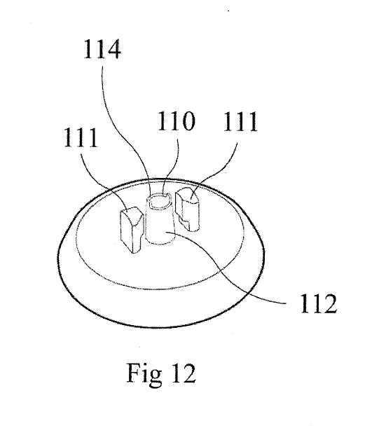

With reference to FIG. 12, the illustrated embodiment of a male portion 110 of the unique connector pair has an engaging end 112 that engages with the female portion 120 to allow transfer of liquid from one piece of equipment to another. To prevent engagement with other connectors known at the time of filing this specification, the engaging end 112 has a diameter that is different from known conventional connectors. Male portion 110 further includes at least one blocking member, to block access to engaging end 112 by other known connectors other than corresponding unique female portion 120. In the illustrated embodiment, the blocking member is provided by an opposed pair of blocking arms 111. However, other blocking members, such as a single blocking arm 111 or a generally cylindrical wall that is generally concentric with engaging end 112, or portions of such a wall, may also be used. The shape of the blocking member is not critical, so long as the blocking member accommodates female socket 124 when male portion 110 and female portion 120 are engaged.

To prevent a flush mating connection from being formed with engaging end 112, the tip of engaging end 112 may be provided with at least one projection 114. Projections 114 prevent the formation of a temporary flush mating connection of male portion 110 with other known connectors. While projections 114 are shown in the illustrated embodiment as a pair of opposed projections, projections 114 may be disposed in any configuration, and may be of any shape, so long as projections 114 do not interfere with fluid flow through the connector pair or engagement with female portion 120. Thus, male part 110 only permits proper fluid flow when it is properly and fully engaged with the compatible female portion 120 of the unique connector pair, and does not permit proper fluid flow into or out of any conventional syringe systems.

With reference to FIG. 13, the illustrated embodiment of a female portion 120 of the unique connector pair has a female socket 124. Female portion 120 further includes syringe fluid tube 128, which is disposed within female socket 124 (i.e. syringe fluid tube 128 is an inner fluid tube in female socket 124). Syringe fluid tube 128 may be made from transparent or semi-transparent material, as may other portions of female portion 120, to allow fluid meniscus 130 to be readily observed.

To facilitate the engagement of connector pair 110, 120, in the illustrated embodiment, the interior surfaces of blocking arms 111 are dimensioned to mate with gaps 122 in the female socket 124 on the outside of female portion 120. When mated, blocking arms 111 engage with a helical slot 126 in female socket 124 which, when male portion 110 and female portion 120 are rotated relative to one another, causes a tight seal to be formed between engaging end 112 of the male portion and syringe fluid tube 128 on female portion 120. Female portion 120 may further have an elastomeric portion (not shown) to facilitate the formation of a tight seal.

To engage female portion 120, the outer surface of engaging end 112 is dimensioned so as to fit within female socket 124, while the inner surface of engaging end 112 is dimensioned to engage with the outer surface of syringe fluid tube 128 to securely overlap syringe fluid tube 128. This facilitates the formation of a tight seal, and further because the engagement between male portion 110 and female portion 120 takes place on the outer surface of syringe fluid tube 128, the drug inside syringe 71 will not be displaced by the insertion of male portion 110 onto female portion 120. This is in contrast to conventional reversed connectors, as insertion of the male needle into a conventional female socket on a syringe results in the displacement of the drug from within the conventional female socket.

The safety connector described above may also be utilized in spinal medication administration systems incorporating sterile bags and flexible tubing sets, for example for medications administered by way of drip or pump, by incorporating engageable male and female portions of the unique connector pair 110, 120 on portions of the administration system which must be connected to administer the medication to a patient (e.g. the bag and any associated flexible medication administration tubing sets).

Additional ancillary apparatus may readily be developed utilizing unique connector pair 110, 120. For example, components of unique connector pair 110, 120 may be deployed on syringe and needle safety adapters, syringe transport caps, IV bag port caps, spinal manometers, tubing, stop-cocks, and the like.

While a number of exemplary aspects and embodiments have been discussed above, those of skill in the art will recognize certain modifications, permutations, additions and sub-combinations thereof. For example:
In some embodiments, removal of the vial contents 4 from the vial handling system 30 may similarly be through a port beneath a removable cap; however, the port may be in the form of a conventional compatible (tapered or twist lock or otherwise) syringe connector which allows removal of the contents via a conventional syringe, without its needle. This form of the vial handling system 30 does not maintain the full safety security system features, but does allow convenience and cleanliness in handling and storage, compared to conventional vial handling procedures.
The positions of the male part 110 and the female part 120 on the various components of the system may be reversed, such that the needle connector 92 and vial housing connector 61 form a female part 120 of the connector pair, and syringe connector 89 forms a male part 110 of the connector pair.
   It is therefore intended that the following appended claims and claims hereafter introduced are interpreted to include all such modifications, permutations, additions and sub-combinations as are within their true spirit and scope.

What is claimed is:

1. A vial adapter for managing the removal of vial contents comprising:
at least one vial gripping member adapted to permanently receive the vial;
at least one window dimensioned to permit access to remove a cap on the vial, an angle defined between a surface on a membrane of the vial and an upper portion of the window being less than 80 degrees; and
a filler pin movable relative to the vial gripping member to pierce a membrane on the vial.

2. A vial adapter according to claim 1, wherein the angle defined between the surface of the membrane of the vial and the upper portion of the window is less than 55 degrees.

3. A vial adapter according to claim 1, wherein the vial gripping member comprises a plurality of vial gripping arms.

4. A vial adapter according to claim 3, wherein each of the vial gripping arms comprises an inwardly tapered lower surface and a generally flat upper surface.

5. A vial adapter according to claim 3, wherein the vial gripping arms further comprise a plurality of adapters to secure vials having a range of different sizes.

6. A vial adapter according to claim 1, further comprising a male end connector portion of a unique connector pair through which the vial contents may be removed, the male end connector portion comprising an engaging end dimensioned to fit within a female socket on a female end connector portion of the unique connector pair, and dimensioned to securely overlap an inner fluid tube on the female end connector portion.

7. A vial adapter according to claim 6, wherein the filler pin comprises a piercing stem having first and second lumens extending through a tip of the piercing stem, the first lumen being in fluid communication with the male end connector portion.

8. A vial adapter according to claim 7, wherein the second lumen is in fluid communication with the outside atmosphere, the vial adapter further comprising a filter between the second lumen and the outside atmosphere.

9. A vial adapter according to claim 7, wherein a tip of the piercing stem is barbed.

10. A reversed connector pair for use with pharmaceutical agents comprising:
a female end connector portion having a female socket with an inner fluid tube in fluid communication with a body of a syringe; and
a male end connector portion having an engaging end dimensioned to fit within the female socket and securely overlap the inner fluid tube.

11. A connector pair according to claim 10, wherein the male end further comprises at least one blocking member disposed to accommodate the female socket.

12. A connector pair according to claim 11, wherein the male end further comprises at least one projection on a tip of the engaging end.

13. A connector pair according to claim 11, wherein the blocking member is dimensioned to engage with the female socket.

14. A connector pair according to claim 11, wherein the blocking member comprises a pair of opposed blocking arms.

15. A connector pair according to claim 14, wherein the female socket comprises a helical slot and inner surfaces of the blocking arms are dimensioned to engage with the helical slot.

16. A connector pair according to claim 10, wherein the inner fluid tube comprises transparent or semi-transparent material.

17. A drug safety system for injecting a drug from a vial, the safety system comprising:
a vial adapter for managing the removal of vial contents, the vial adapter comprising:
at least one vial gripping member adapted to receive the vial,
a filler pin movable relative to the vial gripping member to pierce a membrane on the vial, and
a male portion of a unique connector pair in fluid communication with the filler pin, the male portion comprising an engaging end; and
a safety syringe for removing the vial contents from the vial adapter, the safety syringe comprising a female portion of the unique connector pair at an end of the safety syringe, the female portion comprising a female socket with an inner fluid tube in fluid communication with a body of the safety syringe;
wherein the engaging end of the male portion is dimensioned to fit within the female socket and securely overlap the inner fluid tube.

18. A drug safety system according to claim 17, wherein the male end further comprises at least one blocking member disposed to accommodate the female socket.

19. A drug safety system according to claim 18, wherein the male end further comprises at least one projection on a tip of the engaging end.

20. A drug safety system according to claim 18, wherein the blocking member is dimensioned to engage with the female socket.

21. A drug safety system according to claim 18, wherein the blocking member comprises a pair of opposed blocking arms.

22. A drug safety system according to claim 21, wherein the female socket comprises a helical slot and inner surfaces of the blocking arms are dimensioned to engage with the helical slot.

23. A drug safety system according to claim 17, wherein the inner fluid tube comprises transparent or semi-transparent material.

24. A drug safety system according to claim 17, further comprising a safety needle, the safety needle comprising:
a body having an opening extending longitudinally therethrough;
a metal needle portion coupled to a first end of the body to permit fluid flow from the body through the metal needle portion;
a male portion of the unique connector pair at a second end of the body; and
a stylette insertable through the longitudinal opening in the body and through the metal needle portion.

25. A drug safety system according to claim 17, further comprising a syringe cap having a male portion of the unique connector pair and being engageable with the female portion of the unique connector pair.
